(19) United States
(12) Patent Application Publication
(10) Pub. No.: US 2025/0345741 A1
(43) Pub. Date: Nov. 13, 2025

(54) SYSTEMS AND METHODS FOR POWER PLANT DIRECT AIR CAPTURE

(71) Applicant: GE-HITACHI NUCLEAR ENERGY AMERICAS LLC, Wilmington, NC (US)

(72) Inventors: Brian S. Hunt, Spring Grove, PA (US); Anil R. Duggal, Niskayuna, NY (US); William D. Gerstler, Niskayuna, NY (US)

(21) Appl. No.: 18/658,985

(22) Filed: May 8, 2024

(51) Int. Cl. B01D 53/04; B01D 53/62

(52) U.S. Cl. CPC B01D 53/0462; B01D 53/0438; B01D 53/62; B01D 2257/504

(57) ABSTRACT

Systems and methods provide heat from extraction and transfer systems for direct air capture. Electricity may be provided to operate the systems. Direct air capture apparatuses work on heat from a coolant loop in the system, to replace condensers, heat sinks, feed reheaters, multiple turbines, and/or fluid separators. Heat, and potentially electricity, are generated in a more heat-favored balance in example systems, to more efficiently power direct air capture. Individual direct air capture units are heated and/or cooled by the fluid coolant to cycle through adsorption and/or desorption. Units may be operated based on their stage of direct air capture, with coolant being differently directed as units' operations and needed temperatures change. Coolant itself may move through different stages of units as it loses and/or gains heat. Systems and methods may be installed in new power extraction plants or retrofitted into existing systems by removal of multiple turbines and condensers.

### BACKGROUND

FIG. 1 is a schematic of related art power extraction train in a power plant having a heat or energy source that transfers energy to a fluid for extraction, such as through a Rankine cycle or similar energy extraction setup. As shown in FIG. 1, a loop may be formed by energetic coolant inlet 5 and extracted coolant outlet 6 flowing from/to the energy source, which could be a gas or coal boiler, nuclear reactor, solar furnace, etc. Coolant inlet 5 provides the energetic fluid coolant, which could be superheated steam, through turbine island 10 for multiple stages of energy extraction. High-pressure turbine 11 may initially receive the energetic fluid at its highest pressure and extract rotational energy, resulting in a significant pressure drop in the coolant across high pressure turbine 11. One or more lower pressure turbines 12 then sequentially extract further rotational energy from the lower pressure coolant received from high pressure turbine 11. Moisture separator 13 or another coolant conditioning apparatus, such as a reheater, may be used between turbine stages to most optimally present the fluid coolant for energy extraction through each turbine. Lower pressure turbines 12 may be specifically configured and staged to receive the expanded and lower-pressure fluid from each prior stage, to extract maximum possible energy from the fluid, such that fluid exiting a final lower pressure turbine 12 may be as close to ambient pressure, condensation, and/or loop re-entry as possible. All rotational energy extracted by turbines 11 and 12 may be used in an industrial process and/or for electricity generation, such as by spinning generator 14. Electricity generated by generator 14 may be transformed or otherwise conditioned in switchyard 15 and sold on grid 20 and/or used to power plant or other local processes.

In the case of a condensable fluid such as steam, one or more condensers 16 may receive the fluid from lower pressure turbines 12. A single condenser 16 may follow a sequence of all turbines 11 and 12, or multiple condensers 16 may be used each with lower pressure turbine 12. Condensers 16 are typically tall, heat-exchanging structures with a large heat sink, such as an external or secondary coolant loop 17 that may circulate between a coolant reservoir, coolant tower, deep ground, etc. With sufficient volume and height, condensers 16 may exchange enough heat out of the primary coolant to cause it to condense and fall through condenser 16 for return through extracted coolant outlet 6. The height of condenser 16 may provide a pressure differential or vacuum to lower pressure turbines 12, to drive fluid through the same. Steam jet air ejector system 21 may additionally draw excess uncondensed fluid, such as steam, from condensers 16 to create a vacuum that moves the coolant through outlet 6 and/or expels off-gas from the loop.

The remainder of FIG. 1 illustrates features common to a light water reactor; however, other plant types may have similar adaptations outside turbine island 10. One or more feedwater pumps 1 and condensate return pumps 2 drive the fluid through the loop to coolant outlet 6 where it may return to the heat source. Heat exchangers 3 and feedwater heaters 4 may restore heat to the fluid so that it is ready for phase change or other expansion and pressure increase from coolant outlet 6. Higher-temperature coolant from inlet 5 may be routed through exchanger 3 and heaters 4 to achieve this heating, and ultimately returned to condenser 16. Cleanup line 7 may feed coolant through a purifier or other cleanup structures to maintain desired coolant chemistry as it returns in coolant outlet 6. A storage or condensate tank 9 may provide make-up of coolant fluid to outlet 6 or other plant usage 8.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems that provide heat and/or electricity to directly capture a substance, such as a contaminant, pollutant, valuable compound, etc., from a combined flowstream, and methods of so capturing with an energy transfer cycle. Example embodiments may include a thermodynamic cycle, such as a Rankine Cycle, where a fluid coolant moves through a complete circuit from a heat source, to an extractor like a turbine, to a direct air capture assembly, and back to the heat source. The direct air capture assembly uses heat from the coolant to isolate out or purify the substance, such as through regenerative adsorption media adsorbing carbon dioxide from atmospheric air, which in turn prepares the fluid coolant for reentry back to the heat source. Example systems may thus omit one or more condensers, tertiary or environmental heat sink loops, feed reheaters, multiple turbines, fluid separators, and/or coolant cleanup resin beds, thus simplifying the system while achieving direct capture of the substance. Example systems, while simpler, may provide additional heat and less electricity in a ratio for optimal, long-term, steady state direct air capture.

Example embodiment systems may use a variety of example DAC units within the assembly, including units that use the fluid coolant for desorption, heat-up, and/or cool-down. For example, units having completed adsorption may use hot coolant to warm up and achieve desorption temperature. Similarly, units having completed desorption may use cooler coolant to cool down to adsorption temperature. Units at ambient or adsorption temperatures may be insulated from coolant entirely, receiving no heat or flow from the same. In this way several units may be staged based on what temperature of coolant best aids their operation, and coolant of the appropriate temperature may be routed to each stage. As units complete operations and move into different stages, different temperature coolant may be routed to the units. This includes sequential coolant movement from unit to unit as the coolant itself loses and/or gains heat. Cycles may be repeated, through any number of units, resulting in continuous, steady state direct air capture balanced electrically and thermodynamically with the fluid coolant looping.

Example systems may direct air capture assemblies used therein may be configured to achieve desired coolant properties for long-term operation, with higher heat-to-electricity ratios than conventional power operations. For example, a single turbine may be used, generating just enough power to operate the system with an air capture assembly. This may allow hotter, higher-energy coolant to be directly used for direct air capture. A sufficient number and insulation of direct air capture units may cool the coolant to an ideal temperature and phase for re-entry to the loop and heat source. A heat exchanger or reboiler may also be used to balance incoming and outgoing coolant from the direct air capture assembly to desired temperatures based on flow rate. For example, a direct air capture assembly may receive superheated steam at about 345° F. from a high pressure turbine, and then return condensed liquid water at about 120-230° F. But any temperature and phase difference is possible, for any flow rate, with appropriate direct air capture assembly configuration, including capture unit numbers, stages, insulation, regeneration, and reboiler/reheater.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is a schematic of a related art turbine island in a commercial power plant.

FIG. 2 is a schematic of an example embodiment energy extraction system with direct air capture.

FIG. 3 is an illustration of an example embodiment direct air capture assembly useable with example embodiment systems.

FIG. 4 is an illustration of the example embodiment direct air capture assembly useable with example embodiment systems.

FIG. 5 is an operations flow among stages of direct air capture units in an example embodiment direct air capture assembly.

FIG. 6 is a schematic of example valving useable in example embodiment direct air capture assemblies.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that existing Rankine cycle power plants and industrial processes, and other power extraction cycles, are poorly balanced between temperature and electricity generation (if any) for use in direct air capture, especially in utilizing heat from an energy transfer fluid to operate capture media. These cycles use several stages of turbines, condensers, and/or reheaters that are complicated and difficult to reconfigure for use in direct air capture modules. Coolant available from existing cycles may be at an ineffective temperature and/or pressure to move through direct air capture structures and regenerate media therein. To overcome these newly-recognized problems as well as others, the inventors have developed example embodiments and methods described below to address these and other problems recognized by the inventors with unique solutions enabled by example embodiments.

The present invention is systems and methods for power plant direct air capture. In contrast to the present invention, the few example embodiments and example methods discussed below illustrate just a subset of the variety of different configurations that can be used as and/or in connection with the present invention.

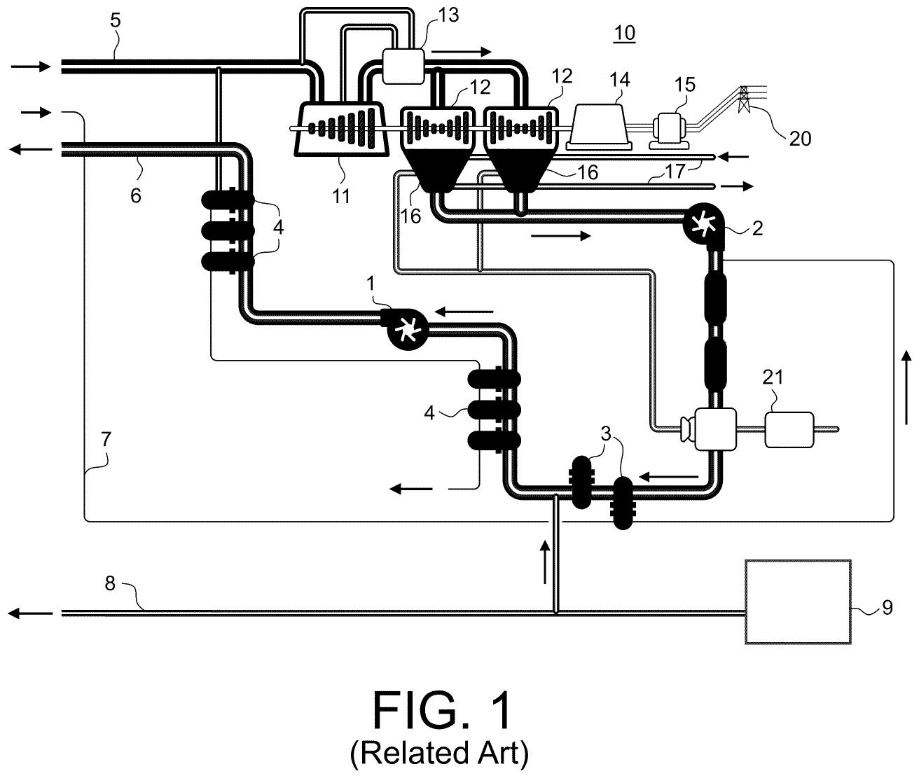

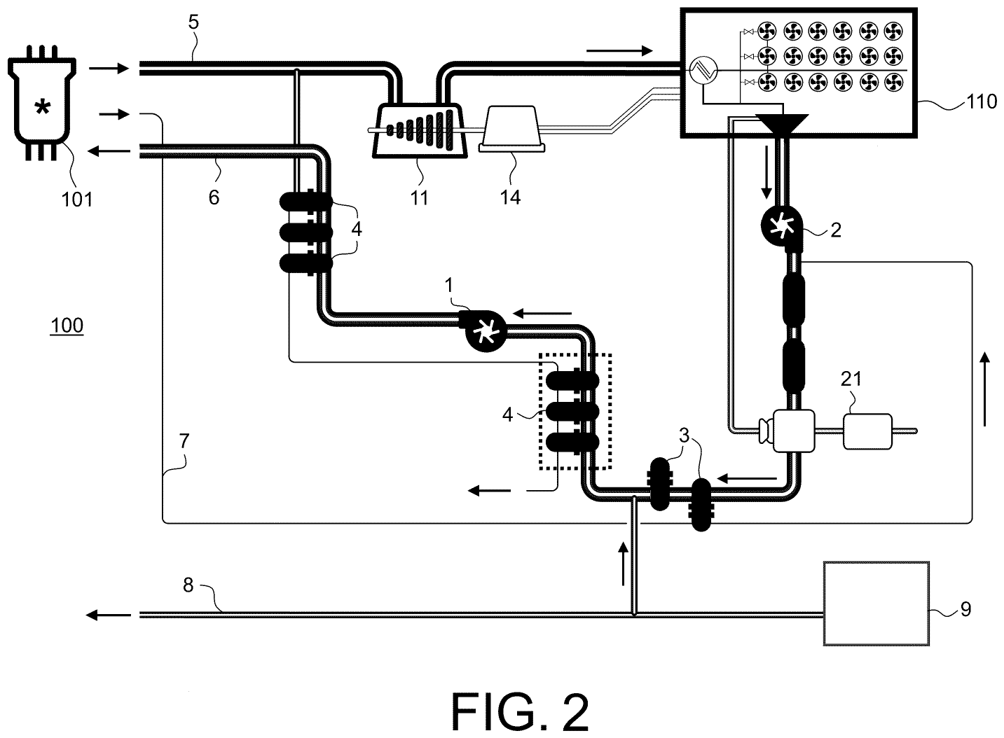

FIG. 2 is a schematic of an example embodiment direct air capture plant 100. As shown in FIG. 2, a coolant loop with inlet 5 and outlet 6 is arranged with heat source 101, such as a geothermal well, solar boiler, coal furnace, nuclear reactor, etc. operating on a Rankine Cycle or similar energy extraction thermodynamic loop. Unlike the related art system of FIG. 1, example embodiment system 100 includes direct air capture (DAC) assembly 110 receiving the fluid coolant from a turbine island on inlet 5 and feeding the coolant back into outlet 6. DAC assembly 110 separates fluids from ambient or feed air for isolation, such as carbon dioxide sequestration from atmospheric air. DAC assembly 110 may further work on electricity from generator 14, with or without an intervening switchyard and/or grid. Alternatively, DAC assembly 110 may be self-powered or draw electricity from a grid not powered from system 100.

The turbine island in example embodiment system 100 may be greatly simplified, potentially using only high-pressure turbine 11. Input to DAC assembly 110 is coolant exiting turbine 11, which may be relatively higher in energy and pressure, such as superheated steam at approximately 258° F. to 345° F. and significant pressure above atmospheric. No lower-pressure turbine chains, turbine reheaters, moisture removers, and/or condensers may be required in example embodiment system 100. Instead, DAC assembly 110 removes energy, including a substantial temperature drop, from the coolant and/or conditions the coolant to properties suitable for outlet 6 as part of a capturing process. In this way, the amount and properties of coolant entering DAC assembly 110 are balanced with the electrical and operating requirements of DAC assembly 110 to capture and separate components in desired amounts. Example embodiment system 100 may be created from existing power plants by removing turbines and condensers and any other unnecessary components, and connecting the coolant loop to a DAC assembly, or example system 100 may be created in a new dedicated power extraction cycle that never needs the additional components.

DAC assembly 110 may be any form of direct air capture system requiring heat to separate out the targeted air component, with the heat in example embodiment system 100 being provided by the fluid coolant. For example, DAC assembly 110 may use an adsorption media that preferentially adsorbs a particular compound, gas, pollutant, etc. from a fluid stream. This could be a temperature swing adsorption unit capturing large amounts of carbon dioxide from ambient atmospheric air, for example. High temperature and pressure fluid coolant from example embodiment system 100 may both regenerate the adsorptive media and drive fluid flow through the system. Several different adsorptive media with temperature regeneration are useable in DAC assembly 110, including those disclosed in FR Patent 3128813 to Amphoux et al.; WO Pat Pub 2006/112977 to Knaebel; WO Pat Pub 2022/058125 to Hillel et al.; and WO Pat Pub 2023/055713 to Jewett et al., each of which is incorporated herein by reference in its entirety.

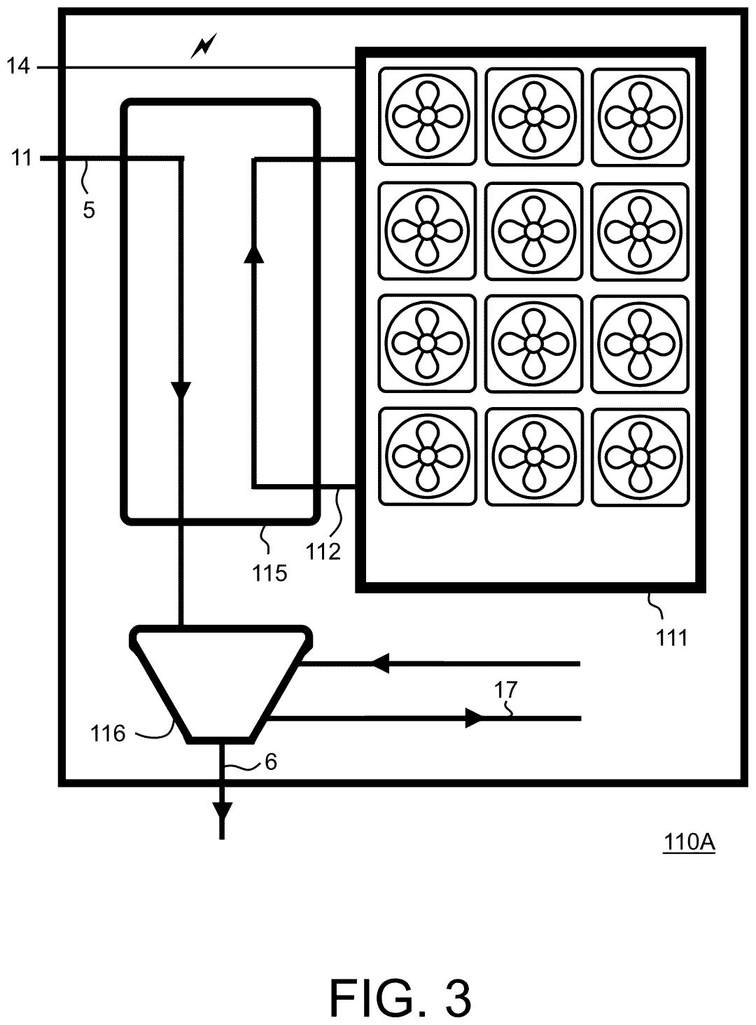

FIG. 3 is an illustration of an example embodiment DAC assembly 110A that uses the energetic coolant fluid from example embodiment system 100, with the coolant isolated from the individual DAC units. As shown in FIG. 3, heat exchanger 115 may transfer heat from the coolant line, such as entry 5 discharging from high pressure turbine 11, of example embodiment 100 to a separately-contained working fluid line 112 of DAC subassembly 111. Heat exchanger 115 may be any type of heat exchanger, such as a cross-flow, helical, thin-tube, reboiler, etc. with internally-separated flow paths allowing desired heat exchange with fluid routing to the various flow paths connected thereto in example embodiments. The coolant may be, for example, superheated steam at approximately 345° F. exiting the turbine. Working fluid line 112 may selectively flow through one or more DAC units of subassembly 111, providing desired regenerative heating to desorption elements therein. In this way, heat from fluid coolant running through entry 5 ultimately from a plant heat source may be transferred to and work to cause direct air capture in DAC subassembly 111.

DAC subassembly 111 may further be electrically powered from turbine 11 and generator 14. For example, electricity from generator 14 may be used to operate any fans, valves, compressors, etc. and/or used for movement, compression, and/or transformation of separated substances. DAC subassembly 111 may be sized to substantially absorb all energy added through heat exchanger 115 at steady-state conditions. Condenser 116 may condense all cooled coolant from heat exchanger 115 back to liquid or another desirable temperature for coolant outlet 6. For example, coolant may be cooled to approximately 130° F. or cooler for use in a resin ion exchange demineralizer. Condenser 116 may use secondary coolant loop 17 that may circulate between a coolant reservoir, coolant tower, deep ground, etc. as a heat sink. Alternatively or additionally, fluid coolant exiting heat exchanger 115 may be condensed or otherwise at a temperature and pressure compatible with coolant outlet 6.

Example embodiment DAC assembly 110A can receive electricity and/or higher-energy coolant exiting from a high-pressure turbine in an appropriate steady-state balance to fully heat sink energy generated from heat source 101 in example embodiment system 100 and power DAC subassembly 111. For example, energy from source 101 may be delivered to DAC subassembly in an approximate 3:1 or 4:1 ratio of heat to electricity by eliminating turbines, decreasing heat exchangers, increasing fluid coolant superheat, etc. in example embodiment system 100. Turbine 11 and generator 14 may be sized and rated only to provide electricity to power DAC subassembly 111 and any operations of example embodiment system 100, with potentially no outside grid involvement. The increased enthalpy versus electricity output from plant outputs may better provide steady-state, long term operations to DAC assembly 110A, to potentially deliver long-term large amounts of sequestered and contained substances 113. For example, by flowing and compressing carbon dioxide from DAC units in DAC subassembly 111 regeneratively heated from the coolant, carbon dioxide can be captured from the atmosphere and prepared for other industrial applications, including bulk pressurized gas delivery, fuel synthesis, further sequestration, etc.

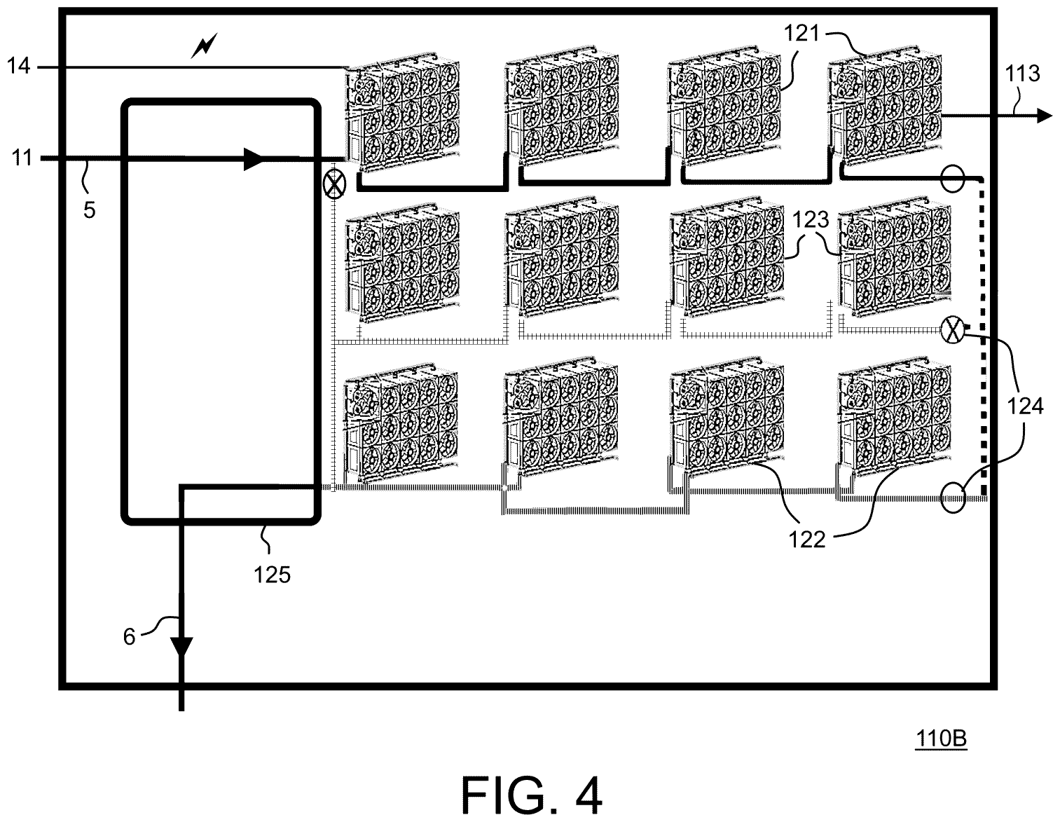

FIG. 4 is an illustration of another example embodiment DAC assembly 110B that uses the coolant from coolant inlet 5 directly in DAC modules 121, 122, and/or 123. For example, the coolant may be superheated steam at 345° F. coming off of a high pressure turbine. Heat exchanger 125, such as a reboiler or other type of heat communication structure like heat exchanger 115 (FIG. 3), may receive the coolant and condition it to a useable temperature for the media of DAC modules 121, 122, and 123. For example, steam may be substantially cooled to 258° F. through heat exchanger 125. Alternatively, the heated coolant directly from turbine 11 may be used in DAC modules 121, 122, and 123 without significant cooling or depressurization.

Through operation of valves 124 and flow conduits regulated by the same, the high temperature coolant passes from heat exchanger 125 to one or more DAC modules 121 for desorption and regeneration of the capture media in desorbing DAC modules 121. Although the coolant is shown flowing serially through a bank of DAC module 121 for desorption, it is understood that all modules, in any number, may be in series or parallel, such as through the use of multi-level manifolds that properly divide the flow among any number of desired desorption modules 121. The high temperature coolant heats the adsorption media in desorbing DAC modules 121 that have previously been exposed to air for adsorption, releasing adsorbed substance 113. For example, carbon dioxide may be released and potentially flowed and sequestered through pressurization once desorbed from DAC modules 121. This flowing and compression may be achieved through fans, valves, and/or compressors powered by generator 14 driven by the higher pressure turbine.

The coolant exiting DAC modules 121 undergoing desorption and media regeneration is substantially cooler, having transferred heat to DAC modules 121 for desorption. The coolant may have lost pressure and/or condensed from the heat transfer to desorbing DAC modules 121. This cooler coolant may then be directed through transitioning DAC modules 122 that have already cooled and adsorbed all compound(s) of interest from an air flow; their adsorption media may be saturated. Transitioning DAC modules 122 may need to be heated to a temperature suitable for material desorption and regeneration, and the fluid coolant from desorbing DAC modules 121 may provide this heat to transition DAC modules 122 to desorption modules. Again, although transitioning DAC modules 122 are shown in series, both parallel and series arrangements of any numbers are possible with multi-stage manifolds.

Transitioning DAC modules 122 may absorb significant heat from the coolant passing through modules 122 as they heat to a desorption temperature. As a result, coolant exiting transitioning DAC modules 122 may be cooler than that entering, potentially down to a condensation point or ambient temperatures about system 100. This cooler fluid coolant may further be passed back though heat exchanger 125, which may heat the coolant and even boil the same.

Entrance and exit flows and module ordering can be varied in example embodiments. Desired entrance and exit temperatures of coolant may be adjusted based on the adsorbing media operational ranges and achieved through proper heat exchanging and flow from the heat source. For example, a hottest coolant may instead enter transitioning DAC modules 122 at 248-284° F., and be cooled to 212-248° F. at exit from the same, before entering desorbing DAC modules 121 at these cooler temperatures. The coolant may then decrease to ambient temperatures such as 68-104° F. upon exit from desorbing DAC modules 121.

Heat exchanger 125 may be configured with sufficient heat exchange surface area and flow volume to achieve any desired feed temperature of the coolant as it reenters loop outlet 6. For example, heat exchanger 125 may reheat the coolant exiting transitioning DAC modules 122 to approximately 120° F. liquid water that is suitable for cleanup with an ion resin exchange and demineralizer in a nuclear power plant. Or, for example, heat exchanger 125 may reheat the coolant exiting transitioning DAC modules 122 to approximately 230° F. for near immediate re-boiling in the energy source connected to coolant outlet 6. Fewer or no heat exchangers 3 and/or heaters 4 (FIG. 2), or coolant diversion to operate the same, may be required in example embodiment system 100, particularly if fluid coolant returned from DAC assembly 110 is at a higher temperature like approximately 230° F. This may further simplify the overall coolant loop in some example embodiments. Whatever configuration is implemented in DAC assembly 110, the temperature of the coolant within or exiting DAC assembly 110 is substantially lower than its temperature when exiting the turbine, due to heat transfer to adsorption media driving direct air capture.

In FIG. 4, modules 123 may be adsorbing from an airstream and may be at a lower temperature. Adsorbing modules 123 may be isolated from the fluid coolant by valves 124 isolating coolant lines into the same, such that modules 123 are not heated while they absorb. As such, valves 124 may conditionally flow coolant of varying temperature and energy to DAC modules depending on their status. Valves 124 may open and close to isolate different DAC modules and flow coolant at different heating temperatures through other DAC modules based on their changing status. All components for physical operations and treatment of the airflow and sequestered component from the same, including valves, fans, compressors, synthesizers, etc., may be operated by electricity from generator 14 or another electricity source.

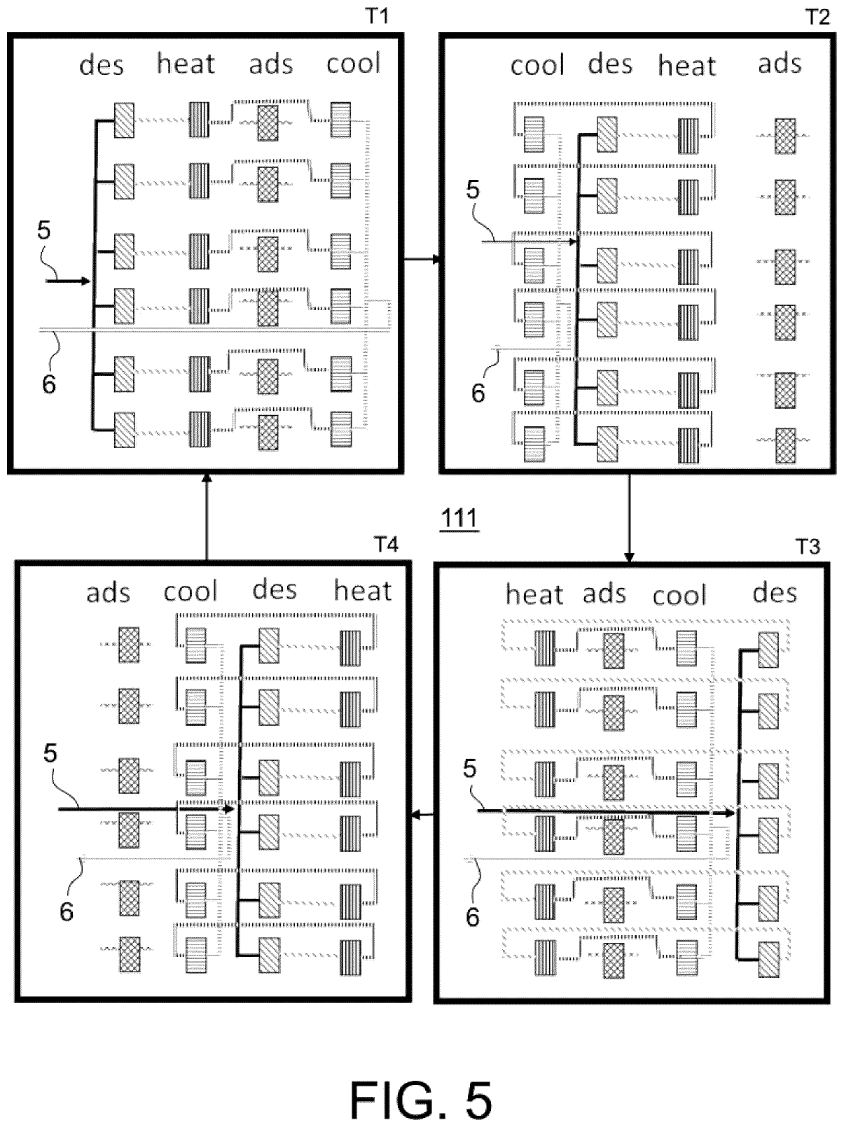

FIG. 4 illustrates an example with three types of DAC modules 121, 122, and 123 varying between adsorbing, desorbing, and transitioning. Additional stages and types of DAC module operation are equally useable in example embodiments. FIG. 5 is an illustration of a cycle of DAC modules in DAC subassembly 111 operating between 4 different modes and times. As shown in FIG. 5, DAC modules undergo desorption (des), heating (heat), adsorption (ads) and cooling (cool), with coolant of an appropriate temperature flowing among these modules.

At an initial time, T1, hottest coolant flows initially into the desorption modules (des), heating the same to desorb the compound of interest from the adsorption media. The coolant then into the heating modules (heat) that are cool from having just completed adsorption from ambient or flowed flows, raising them to desorption temperatures. The coolant, now cooler, then bypasses the adsorption modules that are cool and actively adsorbing (ads), and flows into the cooling modules (cool) that have just completed desorption and are returning to cooler adsorption temperature, thus heating the coolant. Coolant may condense and/or cool to useable feed temperatures through these stages of modules in DAC subassembly 111. Through these stages, the hottest coolant is cooled and then reheated to useable temperatures, while transferring heat to/from modules as needed for media adsorption and desorption.

In FIG. 5, at T2, valving and coolant flow paths redirects the coolant circuit as the modules change temperature and status. In T2, the coolant flows into newly desorbing modules (des), then into newly heating modules (heat), bypasses newly adsorbing modules (ads), and then into newly cooling modules (cool). Once these processes are complete, at T3, valving and ducts or piping advances the cycle further based on the changed modules status. Then at T4, the final sequence of flowing into desorbing, heating, and cooling modules is achieved. As T4 completes, each module in DAC subassembly 111 has completed the four stages of heating, desorption, cooling, and adsorption, and they cycle can restart at T1.

The 4-stage cycle illustrated in example DAC subassembly 111 of FIG. 5 may increase the temperature of the coolant fluid, due to heat transfer to the fluid coolant from cooling DAC modules (cool) immediately prior to return to coolant outlet 6. For example, coolant entering outlet 6 for use in example embodiment system 100 (FIG. 2) may be approximately 230° F., which may permit elimination of some or all reheaters 4. The 3-stage cycle of DAC subassembly 110A/B of FIGS. 4 and 5 may be cooler, due to heat transfer from the fluid coolant to transitioning DAC modules 122. For example, coolant entering outlet 6 for use in example embodiment system 100 may be approximately 120° F., which may permit ion resin bed cleanup of the coolant. Any stage cycle DAC subassembly is useable in example embodiment system 100. As discussed above, heat exchanger 125 may achieve any desired exit temperature of the fluid coolant with proper sizing. Heat exchanger 125 may also be absent, with coolant exiting directly from DAC modules at stages of desired temperature for use in example embodiment system 100.

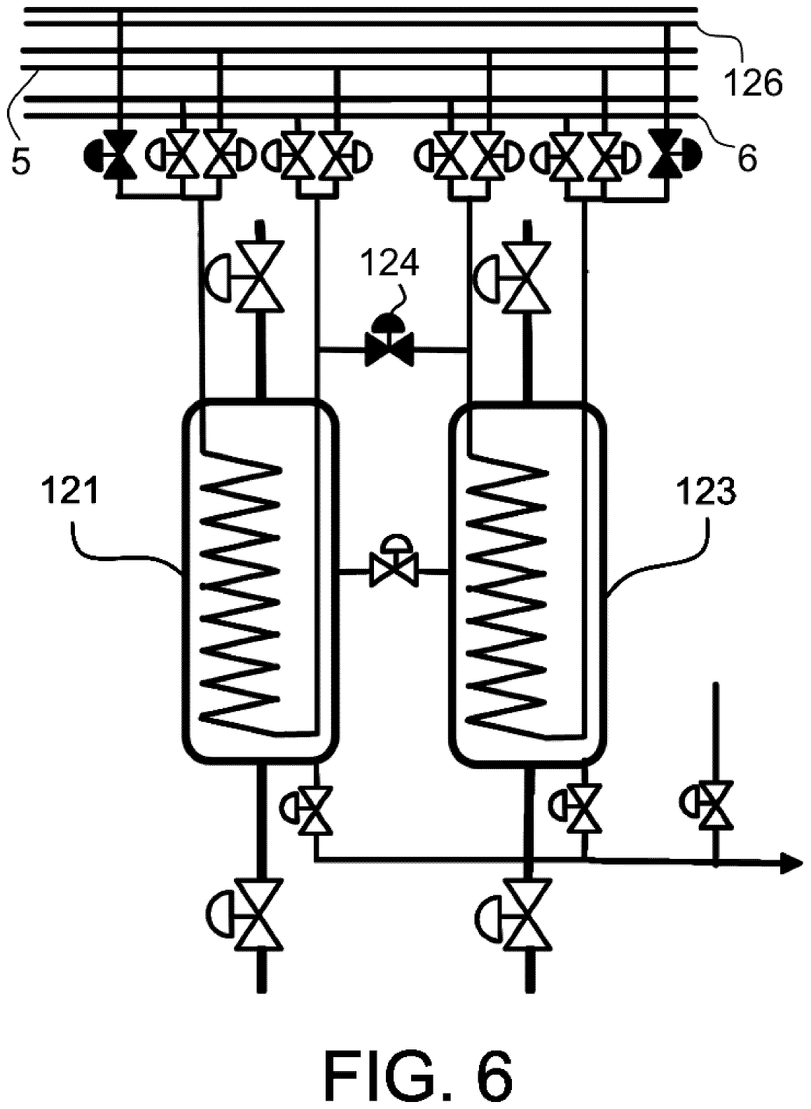

Piping, ducts, pumps, fans, blowers, and/or valves can be used to direct coolant of desired temperature into DAC modules operating with that temperature coolant, and these DAC elements may all be powered with output from generator 14 (FIG. 2) or another source. FIG. 6 is an illustration of an example embodiment piping and valving configuration between DAC modules 121 and 123 that may be used to transfer and recuperate coolant heat among the modules. As shown in FIG. 6, DAC module 121 has just completed desorption from high-temperature coolant passing therethrough. High temperature coolant may be provided through energetic coolant inlet 5, for example. Valve 124 may then be opened upon determination that desorption has completed, allowing the hot coolant to flow into DAC module 123 that has just completed adsorption. This hot coolant may aid in heating DAC module 123 to the desorption temperature, thus cooling the coolant. The cooled coolant from DAC module 123 may then be routed to recuperation line 126 that in turn feeds into DAC 121 having completed desorption and ready to be cooled by the coolant. Coolant may eventually be routed into extracted coolant outlet 6 at a desired temperature, such as after cycling through several modules 121 and 123 for heat exchange to aid adsorption and desorption.

Some example embodiments and methods thus being described, it will be appreciated by one skilled in the art that examples may be varied through routine experimentation and without further inventive activity. For example, although commercial nuclear power plant systems are used in some example systems, it is understood that other heat generation plants are useable with example embodiments and methods. Variations are not to be regarded as departure from the spirit and scope of the example embodiments, and all such modifications as would be obvious to one skilled in the art are intended to be included within the scope of the following claims. That scope is not to be determined under § 112(f), unless the claims clearly invoke means-plus-function interpretation using “means for” or “step for” wording.

1. A system for powering capture of a substance from an aggregate flow, the system comprising:
a coolant loop configured to carry a fluid coolant;
a heat source on the coolant loop configured to generate and transfer energy to the fluid coolant;
a turbine on the coolant loop configured to extract mechanical energy from the fluid coolant, wherein the coolant loop connects from the turbine to a direct air capture assembly and from the direct air capture assembly to the heat source, and wherein the coolant loop, heat source, and turbine include no condenser.

2. The system of claim 1, further comprising:
the direct air capture assembly, wherein the direct air capture assembly is configured to heat direct air capture units with the fluid coolant from the turbine to a desorption temperature of a capture media of the direct air capture units.

3. The system of claim 2, wherein the direct air capture assembly is further configured to cool the direct air capture units toward an adsorption temperature of the capture media with the fluid coolant having cooled in the direct air capture assembly.

4. The system of claim 2, wherein the direct air capture assembly includes a first stage of direct air capture units, a second stage of direct air capture units, and a third stage of direct air capture units, and wherein each of the first, second, and third stages is configured to interact differently from each other with the fluid coolant.

5. The system of claim 4, wherein the first stage of direct air capture units are configured to receive the fluid coolant at a temperature substantially above the fluid coolant received by the second stage of direct air capture units, and wherein the third stage of direct air capture units are configured not to receive the fluid coolant.

6. The system of claim 5, wherein the first stage of direct air capture units have adsorption media that has adsorbed the substance, and wherein the third stage of direct air capture units have adsorption media that has not adsorbed the substance.

7. The system of claim 4, wherein the direct air capture assembly is configured to rotate the first, the second, and the third stages of direct air capture units through a cycle of interaction type with the fluid coolant.

8. The system of claim 1, wherein the turbine powers an electrical generator, and wherein the turbine and electrical generator produce electricity in an amount only to power the system and the direct air capture assembly.

9. The system of claim 1, further comprising:
the direct air capture assembly, wherein the fluid coolant is water, and wherein the turbine is configured to provide the water as superheated steam to the direct air capture assembly, and wherein the direct air capture assembly is configured to provide the water as condensed liquid to the heat source.

10. The system of claim 9, wherein the direct air capture assembly is configured to provide the water at approximately 230° F., and wherein the coolant loop includes a feedwater pump after the direct air capture assembly, and wherein there is no reheater on the coolant loop between the direct air capture assembly and the feedwater pump.

11. The system of claim 9, wherein the direct air capture assembly is configured to provide the water at approximately 120° F., and wherein the coolant loop includes a resin bed coolant cleanup matrix after the direct air capture assembly to remove impurities from the fluid coolant.

12. The system of claim 9, wherein the heat source is a light water reactor, wherein the coolant loop is an entire primary coolant loop for the reactor, and wherein the turbine is the only turbine in the system.

13. The system of claim 9, wherein the aggregate flow is ambient air, wherein the substance is carbon dioxide, the system further comprising:
a generator powered by the turbine, wherein the generator electrically powers the DAC assembly.

14. A method of operating an energy extraction cycle with a coolant loop carrying a fluid coolant from a heat source to a turbine, the system comprising:
flowing the fluid coolant from the turbine through the coolant loop to a direct air capture assembly;
substantially cooling the fluid coolant through the direct air capture assembly; and
flowing the cooled fluid coolant from the direct air capture assembly back to the heat source without phase change during the flowing the cooled fluid coolant.

15. The method of claim 13, wherein the fluid coolant is water, and wherein the substantially cooling the fluid coolant through the direct air capture assembly condenses the fluid coolant from steam to liquid water.

16. The method of claim 13, wherein the turbine is a single and only turbine through which the fluid coolant passes through the complete coolant loop.

17. The method of claim 13, further comprising:
powering an electrical generator with the turbine; and
powering the direct air coolant assembly with the electrical generator, wherein the turbine and electrical generator produce electricity in an amount only to power the system and the direct air capture assembly.

18. The method of claim 13, wherein the direct air capture assembly includes a first stage of direct air capture units, a second stage of direct air capture units, and a third stage of direct air capture units, and wherein each of the first, second, and third stages is configured to interact differently from each other with the fluid coolant.

19. The method of claim 17, further comprising:
heating adsorption media in the first stage of direct air capture units with the fluid coolant to desorb an adsorbed substance; and
insulating adsorption media in the third stage of direct air capture units from the fluid coolant to adsorb a substance from an air flow.

20. The method of claim 18, further comprising:
flowing the fluid coolant from the first stage to the second stage, wherein the fluid coolant entering the first stage is substantially hotter than fluid coolant entering the second stage; and
rotating the first, the second, and the third stages of direct air capture units through a cycle of interaction type with the fluid coolant.
